(19) United States
(12) Patent Application Publication
(10) Pub. No.: US 2007/0068327 A1
(43) Pub. Date: Mar. 29, 2007

(54) Adjusting device for changing the position of a gearshift lever

(75) Inventors: Joachim Grunberger, Sachsenheim (DE); Dieter Kraxner, Wurmberg (DE)

Correspondence Address: LERNER GREENBERG STEMER LLP, P O BOX 2480, HOLLYWOOD, FL, 33022-2480, US

(73) Assignee: Dr. Ing. h.c. F. Porche Aktiengesellschaft

(21) Appl. No.: 11/501,519

(22) Filed: Aug. 9, 2006

(30) Foreign Application Priority Data
Sep. 14, 2005 (DE) 10 2005 043 728.1

(51) Int. Cl. G05G 1/04

(52) U.S. Cl. 74/523

(57) ABSTRACT

An adjusting device serves to change the position of a gearshift lever of a motor vehicle, in which the gearshift lever is disposed adjacent to a steering wheel in a passenger compartment of the motor vehicle. In order to optimize the adjusting device, it is has a drive device disposed between gearshift lever and steering wheel.

### BACKGROUND OF THE INVENTION

### Field of the Invention

The invention relates to an adjusting device for changing the position of a gearshift lever of a motor vehicle. The gearshift lever is disposed adjacent to a steering wheel in a passenger compartment of the motor vehicle.

An operating console for a motor vehicle is known from, published, non-prosecuted German patent application DE 198 00 073 A1, which bears a plurality of operating elements in the visual and/or manual functional region of the driver. In this case, the operating console has a receiving body for the integration of operating elements or operating units essential for the functioning, and a supporting body for the fastening of further such elements or units. With this embodiment, an arrangement of the elements or units that is more flexible and more appropriate to requirements is sought.

Published, European patent application EP 0 745 501 A2 reveals a device for positioning a shift lever of a motor vehicle. At one end, the shift lever has a ball-type mounting which is disposed in a housing. The housing is connected to a guide bolt which is mounted displaceably in the longitudinal direction of the vehicle in a bearing bracket for the purpose of the longitudinal adjustment of the shift lever.

U.S. Pat. No. 4,821,837 deals with an operating device for a motor vehicle of the working machine category, in which operating elements for actuating working appliances are fastened to a supporting bracket disposed adjacent to a steering device. The supporting bracket is mounted pivotably in the vicinity of a floor assembly of the motor vehicle, to be precise in such a manner that the operating elements, including a steering wheel of the steering device, can be changed in the longitudinal direction of the vehicle with regard to their position.

### SUMMARY OF THE INVENTION

It is accordingly an object of the invention to provide an adjusting device for changing the position of a gearshift lever which overcomes the above-mentioned disadvantages of the prior art devices and methods of this general type.

With the foregoing and other objects in view there is provided, in accordance with the invention, an adjusting device for changing a position of a gearshift lever of a motor vehicle, the gearshift lever being disposed adjacent to a steering wheel in a passenger compartment of the motor vehicle. The adjusting device has a drive device disposed between the gearshift lever and the steering wheel.

It is an object of the invention to take precautions between a steering wheel and a gearshift lever of a motor vehicle such that, first, account is taken of the dimensional ratios of a person controlling the motor vehicle and, second, of the capability of this person when operating the motor vehicle.

The advantages mainly obtained with the invention are to be seen in the fact that an adjusting device for changing the position of the gearshift lever and of the steering wheel is provided, which adjusting device can be used, on account of the drive device between the gearshift lever and the steering wheel, to meet anthropometrical and ergonomic requirements. In this case, the drive device can be influenced in a simple manner by longitudinal movements of the steering wheel in the longitudinal direction of the vehicle. The interaction of the drive device between the steering wheel and the gearshift lever can be realized with little outlay by a coupling linkage. On account of the transmission shaft with a first and a second control lever, the coupling linkage of the drive device can be realized with justifiable measures.

In accordance with an added feature of the invention, the drive device includes a coupling linkage couple between the steering wheel and the gearshift lever. The coupling linkage includes a transmission shaft with a first control lever and a second control lever. The first control lever acts on the steering wheel and the second control lever acts on the gearshift lever. The first and second control levers bound the transmission shaft which runs transversely with respect to the longitudinal direction of the motor vehicle.

In accordance with another feature of the invention, a first connecting rod couples the first control lever to a steering column carrying the steering wheel. A bracket connects the first connecting rod to the steering column. A second connecting rod connects the second control lever to a lower lever arm of the gearshift lever. A ball-and-socket joint is disposed between the second connecting rod and the lower lever arm of the gearshift lever. The second connecting rod and the ball-and-socket joint can be disposed inside of or outside of a supporting tube of the gearshift lever.

In accordance with a further feature of the invention, a slide is provided on which the gear shift lever is mounted and a connecting rod interacts with the slide. Preferably, the slide is mounted in a supporting tube.

Other features which are considered as characteristic for the invention are set forth in the appended claims.

Although the invention is illustrated and described herein as embodied in an adjusting device for changing the position of a gearshift lever, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic, perspective view of a gearshift lever and of a steering wheel, disposed in a passenger compartment of a motor vehicle according to the invention;

FIG. 2 is a diagrammatic, side view of the gearshift lever; and

FIG. 3 is a diagrammatic, illustration of a view approximately in the arrow direction X of FIG. 1 with another embodiment.

### DESCRIPTION OF THE PREFERRED EMBODIMENTS

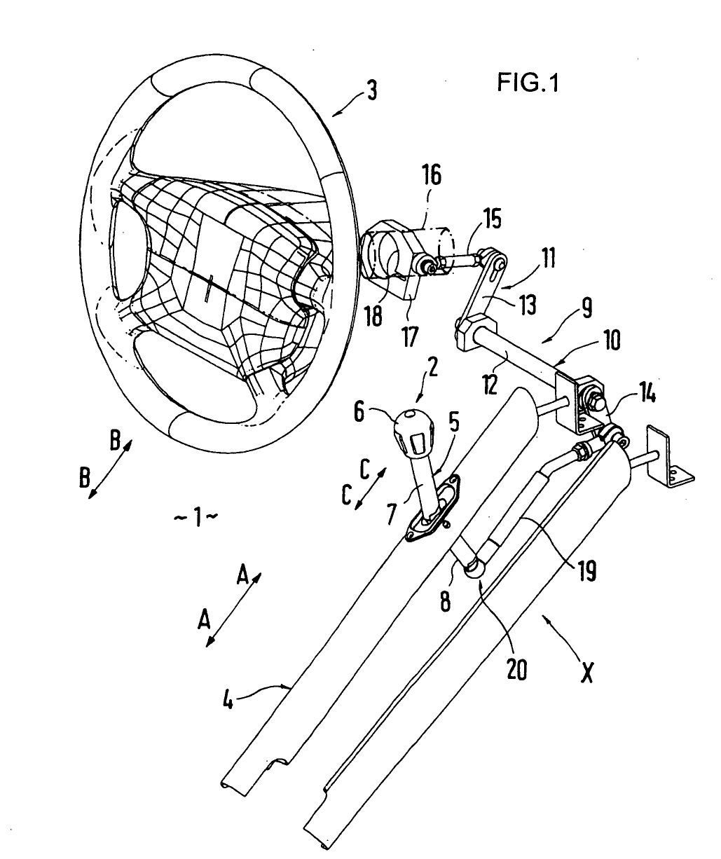

Referring now to the figures of the drawing in detail and first, particularly, to FIG. 1 thereof, there is shown parts of a motor vehicle, for example of the passenger vehicle type, that contains a gearshift lever 2 and a steering wheel 3 in a passenger compartment 1. The gearshift lever 2 is disposed adjacent to the steering wheel 3, on which a supporting tube 4 extending in a longitudinal direction A-A of the vehicle is mounted, and is configured as a two-armed lever 5 with an upper lever arm 7 provided with a shift knob 6, and a lower lever arm 8. To change the position of the gearshift lever 2, for example in the longitudinal direction A-A of the vehicle, i.e. in order to match it to anthropometrical and/or ergonomic requirements or necessities of the driver, use is made of an adjusting device 9 which is defined by a drive device 10 between the gearshift lever 2 and the steering wheel 3. The drive device 10 can be influenced by longitudinal movements of the steering wheel 3 in the longitudinal direction A-A of the vehicle. In this case, both the steering wheel 3 and the gearshift lever 2 can be adjusted by longitudinal movements B-B and C-C, respectively, with it being possible for the adjustment distance of the steering wheel 3 and of the gearshift lever 2 to lie, for example, in the range of from 15 to 25 mm. The adjustment of the steering wheel 3 and of the gearshift lever 2 takes place synchronously according to FIG. 1; however, an asynchronous adjustment is also conceivable, for which purpose a correspondingly configured drive device is to be formed.

The drive device 10 contains a coupling linkage 11 which cooperates with the steering wheel 3 and the gearshift lever 2. The coupling linkage 11 has a transmission shaft 12 with a first control lever 13 and a second control lever 14 in such a manner that the first control lever 13 acts on the steering wheel 3 and the second control lever 14 acts on the gearshift lever 2. The control levers 13 and 14 bound the transmission shift 12 in its longitudinal extent which runs transversely with respect to the longitudinal direction A-A of the vehicle.

The first control lever 13 is coupled with the arrangement of a first connecting rod 15 to a steering column 16 carrying the steering wheel 3. In addition, the first connecting rod 15 is connected fixedly to the steering column 16 via a bracket 17, which bracket 17 surrounds the steering column 16 by of a hole 18.

The second control lever 14 is connected to the lower lever arm 8 of the gearshift lever 2 via a second connecting rod 19. A ball-and-socket joint 20 is provided between the second connecting rod 19 and the lower lever arm 8. According to FIG. 1, the ball-and-socket joint is situated outside the supporting tube 4.

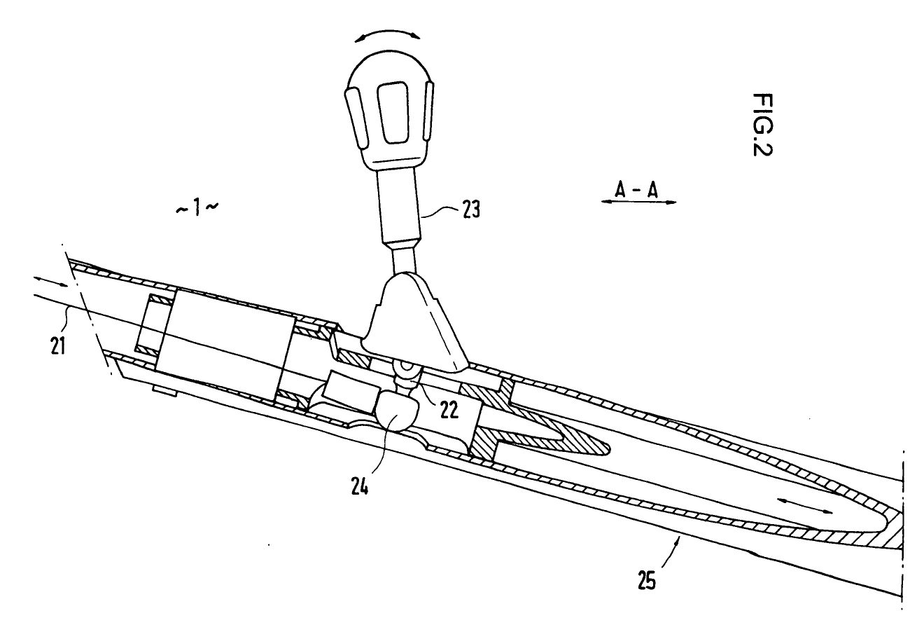

FIG. 2 illustrates a second connecting rod 21 which cooperates with a lower lever arm 22 of a gearshift lever 23, to be precise with the interconnection of a ball-and-socket joint 24 which is disposed within a supporting tube 25.

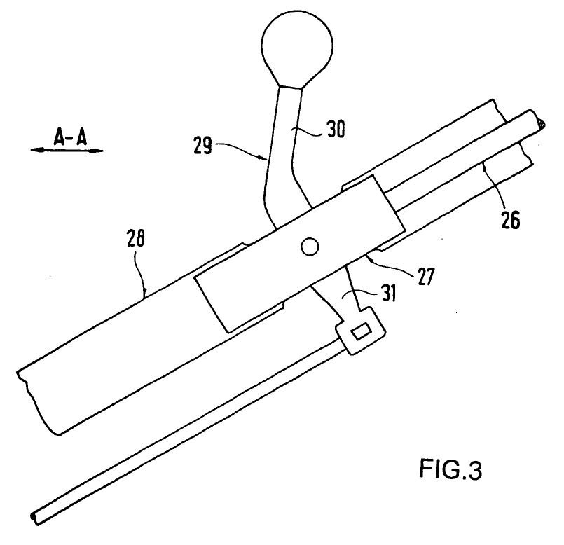

FIG. 3 reveals an embodiment in which a second connecting rod 26 is connected to a slide 27. The slide 27 is mounted in a supporting tube 28 in a manner such that it can be displaced axially, that is to say in the longitudinal direction A-A of the vehicle. The slide 27 serves to support a gearshift lever 29 which, as a two-armed lever, contains an upper lever arm 30 and a lower lever arm 31, the lower lever arm 31 running essentially outside the supporting tube 28.

This application claims the priority, under 35 U.S.C. §119, of German application DE 10 2005 043 728.1, filed Sep. 14, 2005; the prior application is herewith incorporated by reference in its entirety.

We claim:

1. An adjusting device for changing a position of a gearshift lever of a motor vehicle, the gearshift lever disposed adjacent to a steering wheel in a passenger compartment of the motor vehicle, the adjusting device comprising:
a drive device disposed between the gearshift lever and the steering wheel.

2. The adjusting device according to claim 1, wherein said drive device being influenced by longitudinal movements of the steering wheel in a longitudinal direction of the motor vehicle.

3. The adjusting device according to claim 2, wherein said drive device includes a coupling linkage couple between the steering wheel and the gearshift lever.

4. The adjusting device according to claim 3, wherein said coupling linkage includes a transmission shaft with a first control lever and a second control lever, said first control lever acting on the steering wheel and said second control lever acting on the gearshift lever.

5. The adjusting device according to claim 4, wherein said first and second control levers bound said transmission shaft which runs transversely with respect to the longitudinal direction of the motor vehicle.

6. The adjusting device according to claim 4, further comprising a first connecting rod coupling said first control lever to a steering column carrying the steering wheel.

7. The adjusting device according to claim 6, further comprising a bracket connecting said first connecting rod to the steering column.

8. The adjusting device according to claim 4, further comprising a second connecting rod connecting said second control lever to a lower lever arm of the gearshift lever.

9. The adjusting device according to claim 8, further comprising a ball-and-socket joint disposed between said second connecting rod and the lower lever arm of the gearshift lever.

10. The adjusting device according to claim 9, wherein said second connecting rod and said ball-and-socket joint are disposed outside a supporting tube of the gearshift lever.

11. The adjusting device according to claim 9, wherein said second connecting rod and said ball-and-socket joint are disposed within a supporting tube of the gearshift lever.

12. The adjusting device as claimed in claim 4, further comprising:
a slide on which the gearshift lever is mounted; and
a connecting rod interacting with said slide.

13. The adjusting device according to claim 12, further comprising a supporting tube and said slide is mounted in said supporting tube.

14. A method for changing a position of a gearshift lever of a motor vehicle, the gearshift lever being disposed adjacent to a steering wheel in a passenger compartment of the motor vehicle, which comprises the step of:
providing an adjusting device having a drive device for influencing both the gearshift lever and the steering wheel.

15. The method according to claim 14, which comprises performing an adjustment of the steering wheel which subsequently performs an adjustment of the gearshift lever.

16. The method according to claim 15, which further comprises adjusting the steering wheel and the gearshift lever synchronously.

17. The method as claimed in claim 14, which further comprises performing an adjustment of the steering wheel and of the gearshift lever asynchronously.

18. A method for changing a position of a gearshift lever of a motor vehicle, the gearshift lever being disposed adjacent to a steering wheel in a passenger compartment of the motor vehicle, which comprises the step of:
transmitting a position adjustment of the steering wheeling to an adjusting device which in turn adjusts a position of the gearshift lever.

19. The method according to claim 18, wherein an adjustment of the steering wheel causes an adjustment of the gearshift lever.

20. The method according to claim 18, which further comprises adjusting the steering wheel and the gearshift lever one of synchronously and asynchronously.
